(19) United States
(12) Patent Application Publication
(10) Pub. No.: US 2021/0373135 A1
(43) Pub. Date: Dec. 2, 2021

(54) Low Profile Optical Sensor

(71) Applicant: Photon Control Inc., Richmond (CA)

(72) Inventor: Yuriy SYVENKYY, Richmond (CA)

(73) Assignee: Photon Control Inc., Richmond (CA)

(21) Appl. No.: 17/444,343

(22) Filed: Aug. 3, 2021

Related U.S. Application Data
(63) Continuation of application No. PCT/CA2020/050131, filed on Feb. 4, 2020.
(60) Provisional application No. 62/800,595, filed on Feb. 4, 2019.

(51) Int. Cl. G01S 7/481; G01S 17/04; G01S 17/08; G01S 17/42

(52) U.S. Cl. CPC G01S 7/4813; G01S 17/42; G01S 17/08; G01S 17/04

(57) ABSTRACT

The invention pertains to a low-profile, optical sensor to measure distance having a light emitter and a light sensor. More particularly, the optical sensor includes a focusing film having a series of blinds to filter diffused reflected light without the need for a focusing lens. The optical sensors can be used in a variety of applications, including using two sensors to measure thickness of an object or the use of 3 sensors to determine the angle between two surfaces. The invention further pertains to a calibration sensor and method of calibration using 3 or more optical sensors to level a showerhead and a chuck in a semi-conductor deposition apparatus.

### CROSS-REFERENCE TO RELATED APPLICATIONS

This is a Continuation of PCT Patent Application No. PCT/CA2020/050131 filed on Feb. 4, 2020, which claims priority to U.S. Patent Provisional Application No. 62/800,595 filed on Feb. 4, 2019, the contents of which are incorporated herein by reference in their entirety.

### TECHNICAL FIELD

The following generally relates to an optical sensor and system for measuring distance between two points. More particularly it relates to a low-profile optical sensor and a use of multiple sensors to level two plates. Furthermore, the following relates to the use of multiple sensors to calibrate a semi-conductor deposition apparatus.

### BACKGROUND

Optical sensors, particularly laser optical sensors, exist in the art. This classification of sensors functions by emitting a light beam from the laser, which passes through a focusing lens before hitting a target point. The light is diffusely reflected back, through a second focusing lens, to focus the reflected light into a spot on a light sensor. The position of light on the light sensor is then processed and used to determine the distance between the laser and the target point. This method of optically measuring distances is useful in many applications, but the sensor, particularly the focusing lenses, require a suitable amount of space to function effectively.

Without the focusing lenses, the dispersed light falls on a larger area of the light sensor, and the light sensor often cannot get an accurate position reading. Thus, optical sensors, particularly laser optical sensors, have not been found useful for applications in tight spaces where low profile sensors are required.

In semiconductor deposition equipment, for example, significantly accurate alignment between the chuck and the showerhead is needed to obtain a uniform film across the whole wafer. Typically, due to the limited spacing between the chuck and the showerhead, low profile, wafer capacitive gap sensors have been used. A series of 3 capacitive gap sensors are used to measure the gap between the chuck, on which the sensors sit during calibration, and the showerhead. The relative positions of the chuck and showerhead are adjusted until all three sensors are measuring the same gap and thus the chuck and the showerhead are parallel to each other.

Capacitance is an electrical property of two conducting plates, for example, the sensor and the shower head, separated by an insulator, in this case, the air or vacuum between them. As shown in the equation below, it is proportional to the area of the plates and the dielectric constant of the insulator separating them and inversely proportion to the gap separating the plates.

$$Capacitance = \frac{Area * Dielectric Constant}{Gap}$$

Capacitive gap sensors are limited in that their accuracy is dependent on the conductivity of the target material. They do not allow for a high reference distance between the sensor and target, limiting it to close range applications. The can be sensitive to unwanted tilt, spacing and electrical noise, as well as temperature, humidity and overall noise. Each sensor quite large, typically 12-60 mm in diameter, limiting its use for small applications. There remains a need for an accurate, reliable, low profile sensor for measuring distance or leveling plates.

### SUMMARY OF THE DESCRIPTION

There is provided a low-profile, optical sensor to measure distance having a light emitter and a light sensor. More particularly, the optical sensor includes a focusing film having a series of blinds to filter diffused reflected light without the need for a focusing lens. The optical sensors can be used in a variety of applications, including using two sensors to measure a thickness of an object or the use of three or more sensors to determine the angle between two surfaces. The following further describes a calibration sensor and method of calibration using three or more optical sensors to level a showerhead and a chuck in a semi-conductor deposition apparatus.

### BRIEF DESCRIPTION OF THE DRAWINGS

The present description is illustrated by way of example only with reference to the appended drawings wherein:

FIG. 1 is a schematic of the optical sensor and light pattern emitted therefrom;

FIG. 2A is a schematic showing the light path of the optical sensor when the target point is at the maximum distance;

FIG. 2B is a schematic showing the light path of the optical sensor when the target point is at the minimum distance;

FIG. 3 shows the reflected light path and the light sensor;

FIG. 4A is a side view of first embodiment of the focusing film;

FIG. 4B is a side view of a second embodiment of the focusing film;

FIG. 5 is a schematic of two optical sensors used to determine thickness of an object;

FIG. 6 is a schematic of 3 optical sensors used to determine if two plates are level;

FIG. 7 is a schematic depicting use of a calibration sensor in a semi-conductor deposition apparatus;

FIG. 8 is a top view of the calibration sensor;

FIG. 9 is a partly exploded perspective view of the calibration sensor; and

FIG. 10 is a flowchart showing the interactions of the components of the calibration sensor during use.

### DETAILED DESCRIPTION OF THE DRAWINGS

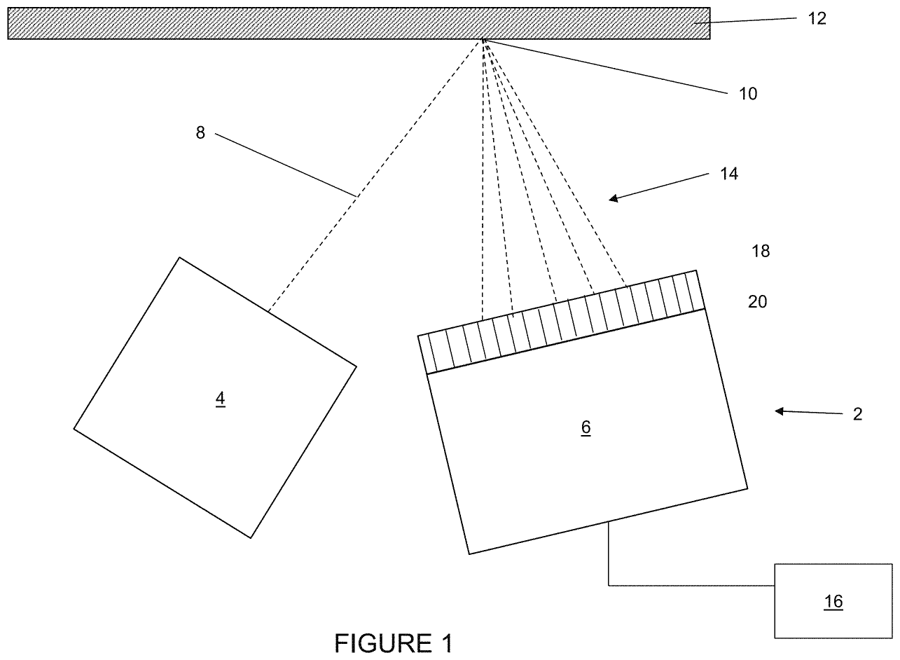

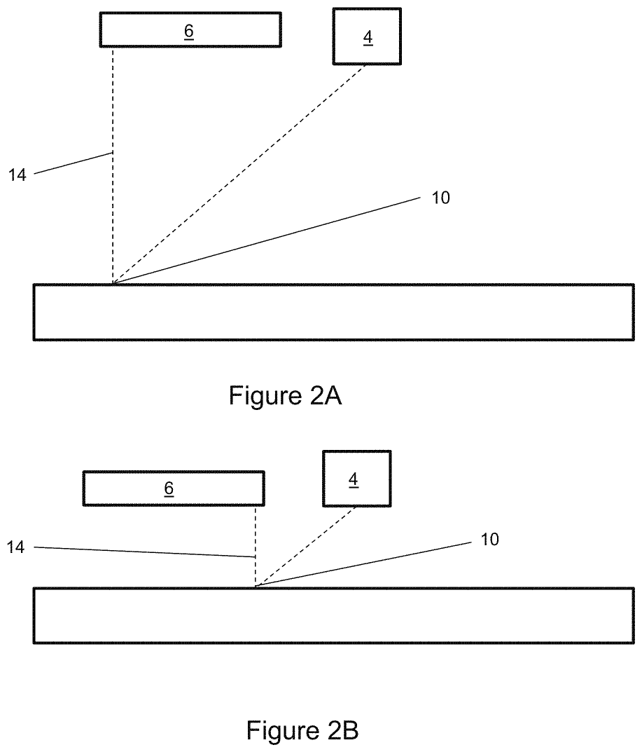

FIG. 1 shows an optical sensor 2 having a light emitter 4, preferably a laser, and a light sensor 6, preferably a charge coupled device (CCD). These elements are preferably contained in a housing (not shown). When in use, the light emitter emits a beam of light 8 directed at a target point 10 on surface 12. The emitted beam 8, hits the target point 10 and is reflected/scattered from the surface 12 to the sensing unit 6 as reflected/scattered light 14. The reflected/scattered light 14 falls on the light sensor 6. The angle at which the light is reflected/scattered from surface 12 is determined by the target point's distance from the light sensor 6. The reflected/scattered light 14 falls on the light sensor 6 and the location at which it falls on the light sensor is used to determine the distance of the target point 10 from the light sensor 6. For example, if the target point 10 is far away, as depicted in FIG. 2A (at the maximum specified range for example), then the reflected light 14 will fall toward the end of the light sensor 6 furthest from the light emitter 4. Alternatively, as illustrated in FIG. 2B, if the target point 10 is at its closest position (at the minimum specified range for example), then the reflected light 14 will land at the opposite end of the light sensor 6 closest to the laser emitter 4. The range of distance in which any particular sensor could measure is partially determined by the size of the light sensor along with the properties of the target surface and light emitter. The received light 14 is processed and analyzed by the signal processor 16, which determines the distance to the target point 10 based on the principle of optical triangulation, known to a person skilled in the art.

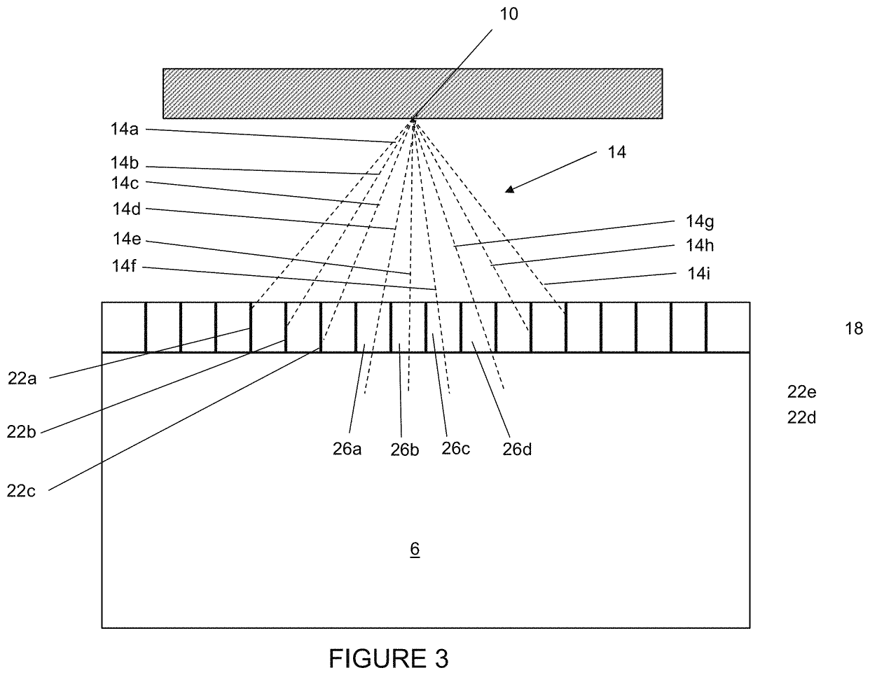

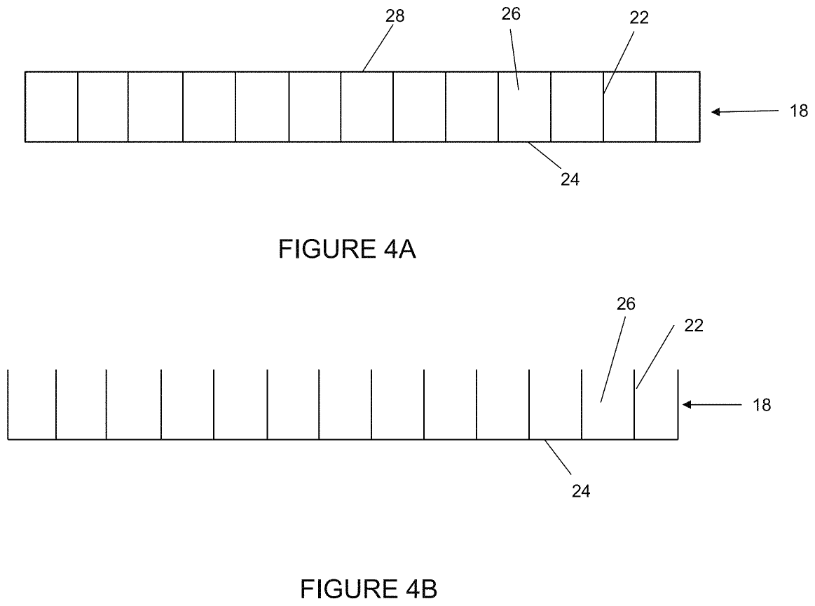

As shown in FIGS. 1 and 3, the reflected light 14 is reflected diffusely from the target point 10. Without first being filtered or focused in some manner, the reflected light would fall on a large area of the light sensor 6 and it would not be possible to measure the distance to the target point 10 accurately. To address this, a focusing film 18 is located between the reflective surface 12 and the light sensor 6. The focusing film 18 is preferably located adjacent the receiving surface 20 of the light sensor 6. In alternative embodiments, the focusing film is spaced from the light sensor 6 but configured such that it does not interfere with the light emitter. As shown in FIG. 4A, the focusing film 18 includes a plurality of blinds 22 extending outwardly from a transparent base surface 24, creating a plurality of windows 26 between each adjacent set of blinds. It is preferred that the blinds extend generally perpendicular to the surface of the light sensor 6 for increased accuracy and reduced light loss. A transparent top surface 28 is included in a preferred embodiment to maintain the positions of the blinds. Optionally, as shown in FIG. 4B, in focusing film 18b the top surface is excluded and the blinds 22 project outwardly from the base 24. Preferably the blinds 22 are evenly space, however, depending on the application, the spacing between the blinds could be customized.

Referring back to FIG. 3, as the reflected light 14 diffusely reflects off the target point 10, it passes through the focusing film18 before falling on the light sensor 6. The focusing film 18 acts to block some of the diffused reflected light 14 from falling on the light sensor 6, resulting a smaller area of the light sensor 6 being activated and, therefore, more accurate measurements. In many applications, without the focusing film or a focusing lens, the sensor would be equally illuminated along its length and no measurement could be determined. For illustration purposes the diffused reflected light 14 has been shown in FIG. 3 as a series of dashed lines 14a-14i, each representing a portion of the diffused light. Light portions 14d, 14e, 14f and 14g, located on the interior of the diffusion pattern, fall on the focusing film 18 at angles which allow the light to pass through windows 26a, 26b, 26c, and 26d respectively. These portions of light fall on the light sensor 6 the position of which is used to determine the distance of the target point 6. However, the portions of light on the outside of the diffusion pattern, including 14a, 14b, 14c, 14h and 14i, pass through the focusing film 18 at such an angle that the light falls on the blinds 22 a, 22b, 22c, 22d and 22e respectively. This prevents these portions of reflected light 14 from contacting the light sensor 6. Since only a portion of the diffused reflected light 14 passes through the focusing film 18, the area of the light sensor activated by light is reduced. The overall effect of the focusing film is that the reflected light 14 is filtered, creating a small area of light on the light sensor, without the need for a focusing lens.

Alone, the optical sensor of the present invention can be used to measure distance or the presence of an object. By adjusting various features, such as the robustness of the housing, the size of the light sensor, spacing and size of the blinds in focusing film, or the light emitter properties, the optical sensor can be adapted for use in a wide variety of applications and environments, from small spaces to outdoor or industrial use. Common applications include, but are not limited to, quality control, error proofing and positioning applications.

With a height at least as small as 8mm, the lens-less design is particularly advantageous in applications in small spaces. Additionally, the optical sensor is robust and can be used under a wide variety of conditions, including temperatures ranging from 20° C. to 65° C., a wide range of humidities and pressures, including in a vacuum.

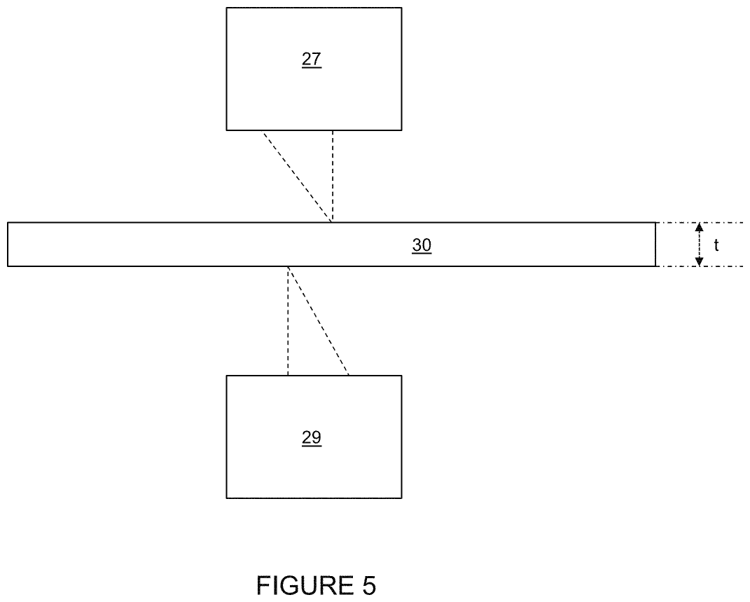

The optical sensors can also be used in pairs. As shown in FIG. 5, the sensors, 27 and 29 could be placed on opposite side of an object 30 to determine the distance from each sensor 32 and 34 to the object 30. This information can then be used to determine the thickness t of the object 30 of interest.

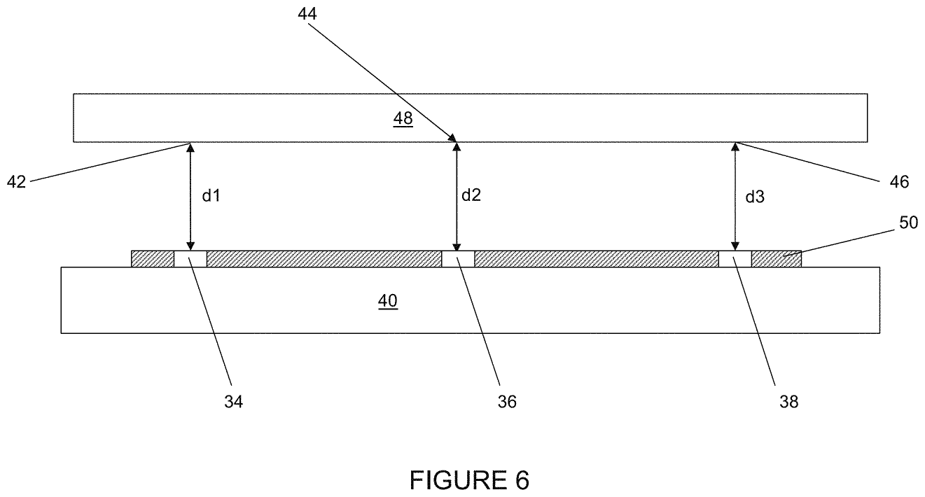

Three optical sensors can be used in combination to determine if two plates are level/parallel. As shown in FIG. 6, three optical sensors, 34, 36 and 38 are configured on a first plate 40 and positioned such that they each emit light onto different target points 42, 44 and 46, respectively, on a second plate 48. The first optical sensor determines the distance d1 between it and the first target point 42, the second optical sensor determines the distance d2 between it and the second target point 44, and the third optical sensor determines the distance between it and the third target point 46. When d1, d2 and d3 are all equal, the plates are level and aligned parallel two each other. Preferably all three sensors are fixed in a common base 50 for ease of use and to maintain their relative positions. With the 3 known distances, the angle of one plate relative to the other can also be calculated. Therefore, this type of sensor could be used to calibrate or set two plates at any relative angle. Although a minimum of 3 sensors is required to determine the angle between two plates, it can be appreciated that more sensors could be used.

In a preferred embodiment, the sensor 60 is contains a communication transmitter, preferably wireless or bluetooth, to transmit measurements in real time. In a further embodiment, a precision accelerometer is included in one or more of the sensors the to measure the inclination of the sensor relative to the earth. The sensor can also be configured to be remotely activated.

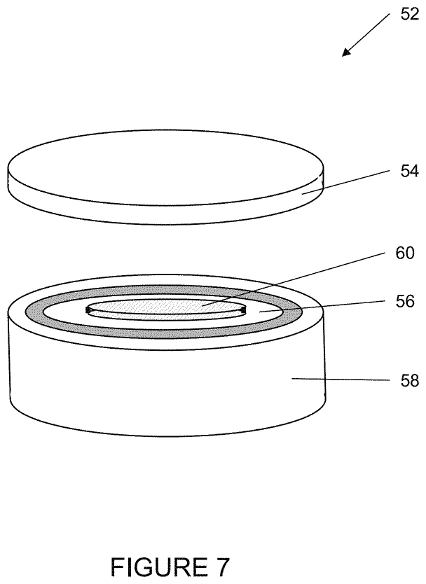

This design is particularly useful in semi-conductor deposition apparatus calibration procedures. FIG. 7 shows a simplified semi-conductor deposition apparatus 52, having a showerhead 54 and a chuck 56 located in a lower housing 58. For simplicity, the chamber surrounding the chuck and shower head and other components found in this type of apparatus have been omitted. In order produce wafer products that have even thickness throughout, it is important that the showerhead 54 and the chuck 56 are level. Thus, before producing a product, the semi-conductor deposition apparatus is calibrated. The calibration sensor 60, containing at least 3 optical sensors, is placed on the chuck and activated to determine at least 3 distances between the chuck and the showerhead. The chuck and/or the shower head is then adjusted until all three measured distances are equal. With the capability to remotely activate the calibration sensor, there is no time limitation on aligning the chuck to the showerhead.

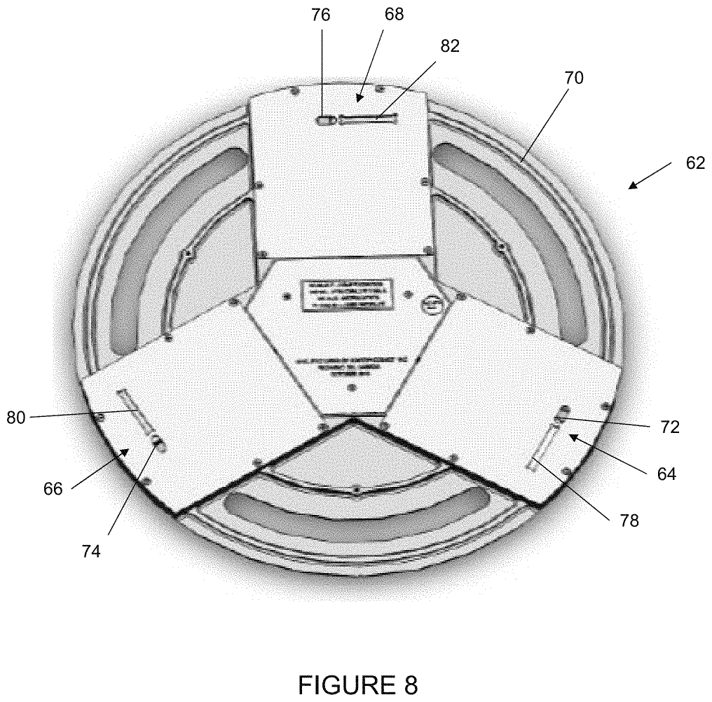

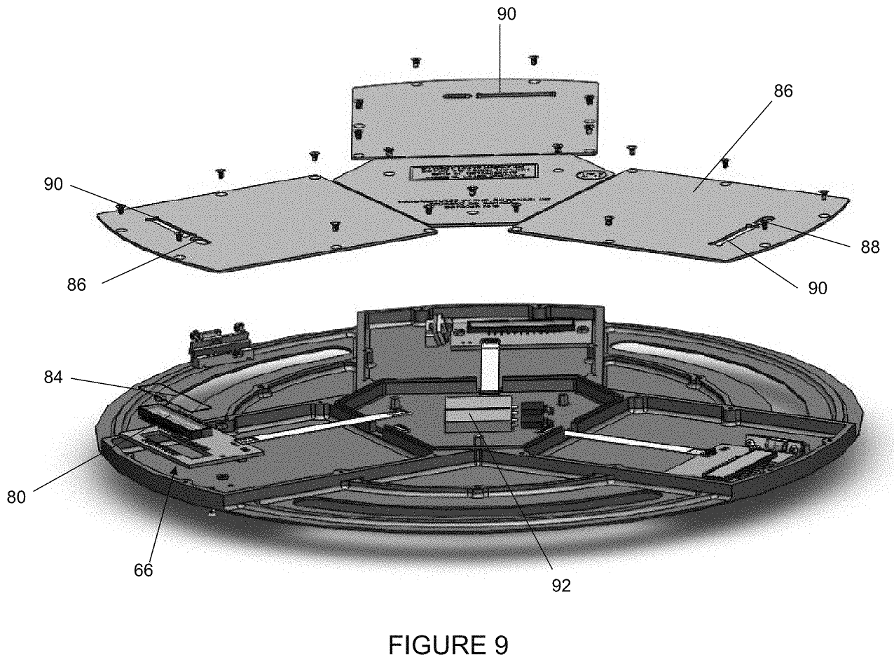

FIG. 8 shows a preferred design of a wafer-like calibration sensor 62 incorporating three optical sensors 64, 66 and 68 arranged on and fixed to a base 70. Although a variety of materials could be used to make the base, preferred embodiments for use in a semi-conductor, potential base materials include, but are not limited to, Meldin, Celazole, Torlon, PEEK, Vespel, anodized aluminum and ceramics, fused silica, silicon, or sapphire. The base is preferably rigid to prevent relative movement between the sensors. Since the distance is typically measured from the sensor position to the target point, rigidness of the base ensures that the distance from the base to the light emitter stays constant. The base is preferably designed such that there is very change in the base properties (for example, expansion or contraction) under different temperature or pressure conditions. Each optical sensor has a light emitter 72, 74 and 76 positioned next to a light sensor 78, 80 and 82 respectively. As can been seen in FIG. 9, which shows an exploded view of optical sensor 66, the light sensor 80 has a focusing film 84 affixed on top thereof. This is consistent for each sensor. A top covering 86 is provided to protect the working components of the calibration sensor 62. A first set of slots 88 are provided to allow each light emitter 72,74 and 76 to emit light and second set of slots 90 are provided in the top covering 86 to expose the light sensors 78,80 and 82. The top covering can be monolithically formed or consist of multiple coverings each protecting specific aspects of the calibration sensor. The top covering can be removably fixed to the base in any form known to a person skilled in the art. In the preferred embodiment shown in the Figures, screws are used.

In the preferred embodiment of the figure, the calibration sensor is round, with the optical sensors 64, 66 and 68 located near the edge of the base and equally spaced about the circumference. By spacing the sensors out as much as allowed by the base, the distance between the three target points measured is greatest. This leads to a more accurate leveling than if the 3 points were closer together.

The center of the base can be used to house other working components, such as the transmitter, preferably wireless or bluetooth, to transmit the measurements to an external transceiver. With this design, the measurements can be used as input into calibration software which can adjust the position of the chuck and/or showerhead automatically in response to the real time measurement. Additionally, the center of the base can be utilized to house a power unit 92 to power the three optical sensors. The power unit preferably is battery based to allow for an entirely wireless calibration sensor, although other power units may be known to a person skilled in the art. Since the preferred embodiment includes the ability to wirelessly activate the sensor, one advantage of the design is that the sensor can be used remotely without releasing the vacuum in the semi-conductor housing.

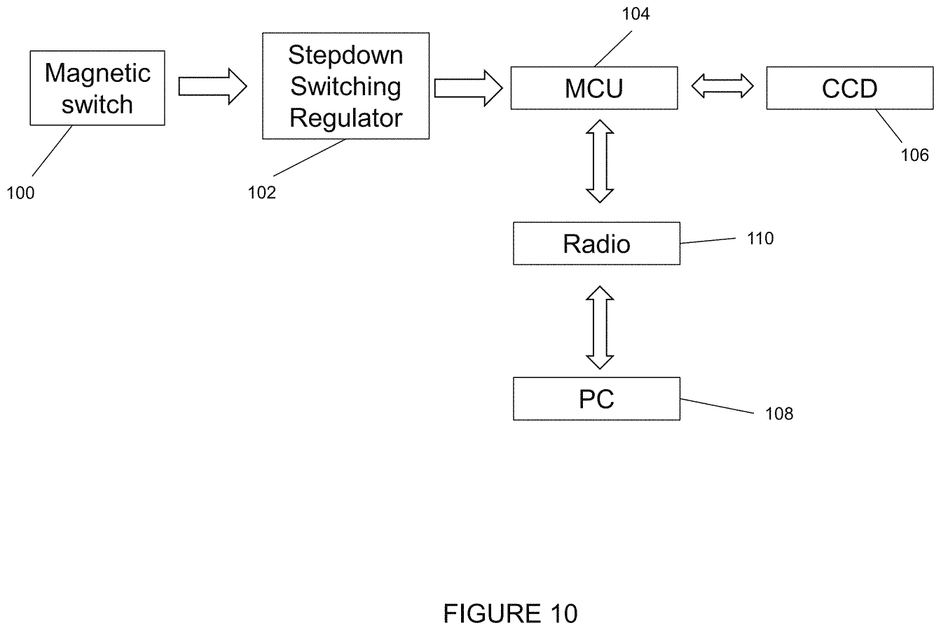

The flowchart of FIG. 10 shows the overall interactions of the calibration system components. The calibration sensor is first activated by magnetic switch in 100. Voltage from the batteries is regulated by the switching regulator 102. Then the microcontroller unit (MCU) is powered initiating software algorithm 104. Data from CCD light sensor is processed 106 and final calculated distance number from each light sensor is send out to PC 108 though the MCU which transmits a radio signal 110 on the radio channel that is received by the PC. One advantages of the magnetic switch is that a robot can move the sensor beside the magnet to activate the sensor. Thus, no human interference is required.

When in use, the calibration system is activated using a magnetic switch and control options are built into corresponding software. The calibration sensor is placed in a closed semi-conductor deposition chamber with no human access during the calibration. The light emitters activate and real time transmission of the 3 distance measurements. The corresponding software compares the distances and determines the optimal adjustments to make to the position of the chuck and/or shower head.

Although a wide range of power is known to be acceptable and would be known to a person skilled in the art, the preferred embodiment includes laser light emitters emitting a maximum power of 0.67 mW at 100 mm, which is considered safe to the unprotected human eye. Other light sources would be known to a person skilled in the art, including, but not limited to, LED or incandescent sources. The shape or wavelength of the beam could also vary from ultraviolet to infrared. However, the preferred embodiment of the calibration sensor further includes light emitters having a working wavelength of 850 nm. Although other light sensor may be functional and known, Linear CCD sensors with a pixel size <10 μm are preferred. The smaller the pixel size, the more accurate the measurement, in a preferred embodiment, a CCD light sensor with a pixel size of 8 μm is used. With this preferred configuration, the target point location is 120 mm±5 mm from the center of the sensor has a measurement range of 15 mm±5 mm with

[symbol]

The scope of the claims should not be limited by the preferred embodiments set forth in the examples but should be given the broadest interpretation consistent with the description as a whole.

1. An optical sensor comprising;
a light source emitting light and directed towards a target point;
a light sensing unit for receiving reflected light from said target point;
a light blocking mechanism positioned between said target point and said light sensing unit to block a portion of the reflected light from reaching said light sensing unit; and
a processing unit to process the light received by the light sensing unit.

2. An optical sensor according to claim 1, wherein said light blocking mechanism comprises at least two or more blinds.

3. An optical sensor according to claim 2, wherein said light blocking mechanism comprises a series of blinds.

4. An optical sensor according to claim 2 wherein said blinds are positioned generally perpendicular to said light sensing unit.

5. An optical sensor according to claim 4 wherein said light blocking means is positioned adjacent said light sensing unit.

6. An optical sensor according to claim 1, wherein said light source is emitted from a reference point; and said processing unit is configured to process the reflected light received by said sensing unit to determine the distance between said reference point and said target point.

7. An optical sensor according to claim 1, further comprising a communication transmitter to communicate information to a receiving device.

8. An optical sensor according to claim 7 wherein said communication transmitter is wireless.

9. An optical sensor according to claim 8 wherein said communication transmitter functions using Bluetooth technology.

10. An optical sensor according to claim 1, further comprising means to activate the sensor remotely.

11. An optical sensor according to claim 1, further comprising a precision accelerometer.

12. An optical sensor according to claim 1, further comprising a housing unit configured to maintain the relative positions of the light source, the light sensing unit and the light blocking means.

13. An optical sensor according to claim 1, wherein said communication transmitter transmits information in real time.

14. An optical sensor according to claim 5, wherein the light sensor is a charge coupled device.

15. A sensor for determining the angle between two surfaces comprising;
at least three optical sensors, each located at a known position relative to a first surface; and
a processing unit;
each optical sensor comprising:
a light source emitting light and directed towards a target point on the second surface;
a light sensing unit for receiving reflected light from said target point;
a light blocking mechanism positioned between said target point and said light sensing unit to block a portion of the reflected light from reaching said light sensing unit;
wherein the processing unit processes output signals from each of the at least three light sensing units and calculates each of the distances between each sensor and each corresponding target point; and
the processing unit uses the measured distances to determine the angle between the first surface and the second surface.

16. A sensor according to claim 15, wherein said light blocking mechanism comprises at least two or more blinds.

17. A sensor according to claim 16 wherein said light blocking means comprises a series of blinds.

18. A method of determining the presence of an object comprising;
emitting a beam of light towards a target point on the object;
blocking a portion of reflected light from falling on a light sensor;
receiving a portion of the reflected light as input on the light sensor; and
using the input, or lack thereof on the light sensor appropriately to determine if the object is present.

19. A method of measuring the distance between two points comprising:
emitting a beam of light towards a target point;
blocking a portion of reflected light from falling on a light sensor;
receiving a portion of the reflected light as input on the light sensor; and
converting the input on the light sensor appropriately to calculate the distance of the target point from a reference point.

20. A method of assessing the angle between two surfaces comprising;
emitting at least three beams of light from at least three corresponding reference points relative to a first surface;
directing the at least three beams of light towards at least three corresponding target points on a second surface;
blocking at least a portion of a reflected light from each of the three beams of light that have reflected off the corresponding target points;
receiving a portion of each of the reflected lights as input into each of three corresponding light sensors;
converting the input on each of the light sensors to determine a distance between each reference point and its corresponding target point;
using the distances between each reference point and its corresponding target point to assess the angle between the two surfaces
